(19) United States
(12) Patent Application Publication
(10) Pub. No.: US 2002/0020038 A1
(43) Pub. Date: Feb. 21, 2002

(54) Lever handles

(76) Inventor: Steven Frank Wilkes, Walsall (GB)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/791,089

(22) Filed: Feb. 21, 2001

(30) Foreign Application Priority Data
Feb. 22, 2000 (NZ) 502957

(51) Int. Cl. B62B 1/00

(52) U.S. Cl. 16/412

(57) ABSTRACT

A lever handle including a lever (11) rotatably mounted with an escutcheon (10) arranged for quick adjustment of the handing (e.g. for use with either a left or right swinging door). The handle includes a stop element (24) sliding between limiting positions (23) to be engaged with a mover (18).

### BACKGROUND TO THE INVENTION

This invention relates to improvements in lever handles.

Lever handles intended f or use with internal door locks are known. Such lever handles can comprise a lever having a boss or the like which is rotatably mounted with an escutcheon plate. The boss includes an angular bore (generally of square cross-section) into which the end of a shaft coupled to the lock can be engaged. By moving the handle in a downward direction the latch tongue or bolt of the lock is retracted. Release of the handle enables the lock tongue/bolt to once again project into the latching position. A backstop is provided in the lever handle construction to prevent the handle from moving in the wrong direction, eg upwards from the rest position.

With such known constructions, handing of the lever handle can be a problem. While it is possible to rotate the escutcheon through, say, 180° to change the handing of the lever handle, this results in the backstop being positioned in the wrong place so that the lever handle needs to be lifted to retract the latch tongue/bolt because the backstop prevents the handle from moving downwardly. To overcome this problem, it is known to have an arrangement whereby the handle can be detached from the escutcheon and then moved to the opposite handing and reassembled. However, this is a time-consuming and fiddly operation.

### SUMMARY OF THE INVENTION

It is an object of the present invention to provide a lever handle whereby the handing of the lever relative to an escutcheon can be changed without needing to disassemble the lever handle.

Broadly, according to one form of the invention, there is provided a lever handle including a lever rotatably mounted with an escutcheon, a stop element movably mounted within said escutcheon, a mover associated with said lever and a limiter to limit movement of the stop element between limit positions.

In a preferred form, the stop element is located for sliding movement along a curved guide. The curved guide preferably has a radius concentric with the axis of rotation of the lever. The limiter can be formed by abutments extending into the guide.

The mover can in one form of the invention be a retainer element for retaining the lever handle with the escutcheon. In this form, the retainer includes a projection which is engageable with a part of the stop element.

### BRIEF DESCRIPTION OF THE DRAWINGS

FIG. 1 is a general assembly perspective view of an internal door set incorporating lever handles embodying the invention,

FIG. 2 is an exploded view of one of the lever handles,

FIG. 3 is a rear face view of a lever handle,

FIGS. 4 5 and 6 show stages of the lever being moved to achieve a lever handle of a different “hand”, and

FIG. 7 is a further pictorial assembled view of the internal door set.

### DESCRIPTION OF THE PREFERRED EMBODIMENT

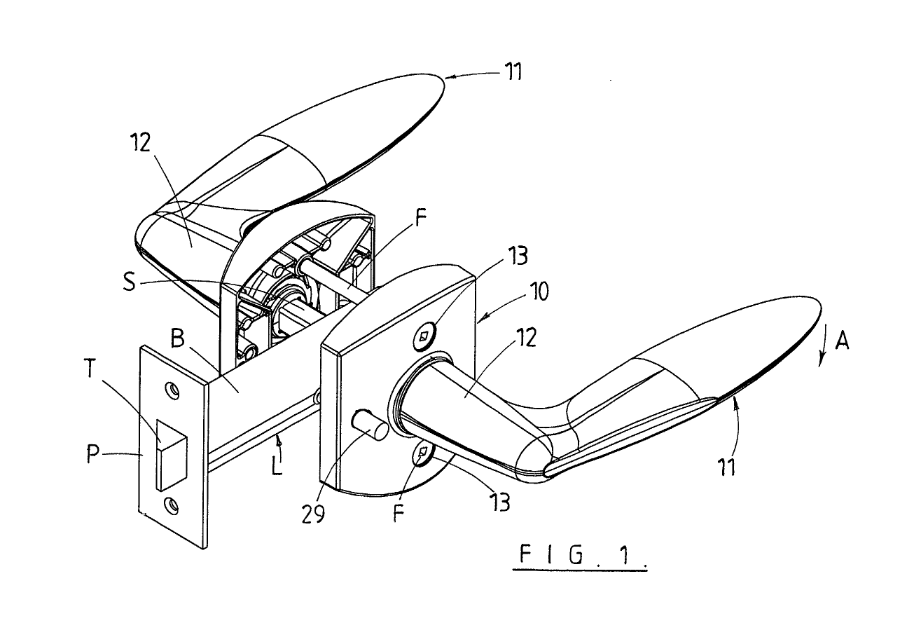

Referring firstly to FIG. 1, there is shown a pair of lever handles incorporating the present invention when combined in an internal door set. The lever handle includes an escutcheon 10 to which is rotatably mounted a lever 11. The lever 11 has a mounting portion 12 which is rotatably retained with the escutcheon 10. Openings 13 are formed in the escutcheon 10 to facilitate the mounting of fasteners F which pass between the pair of escutcheons 10 of the door set and the door to retain the escutcheons in position on the door.

A lock L is located in a conventional manner between the escutcheons 10, the body B of the lock L being, in accordance with normal practice, locating within a cavity in the door. The lock L has a face plate P and projecting from the face plate is a latch tongue T. A shaft S extends between the bodies 12 and engages with a drive member (not shown) of the lock L.

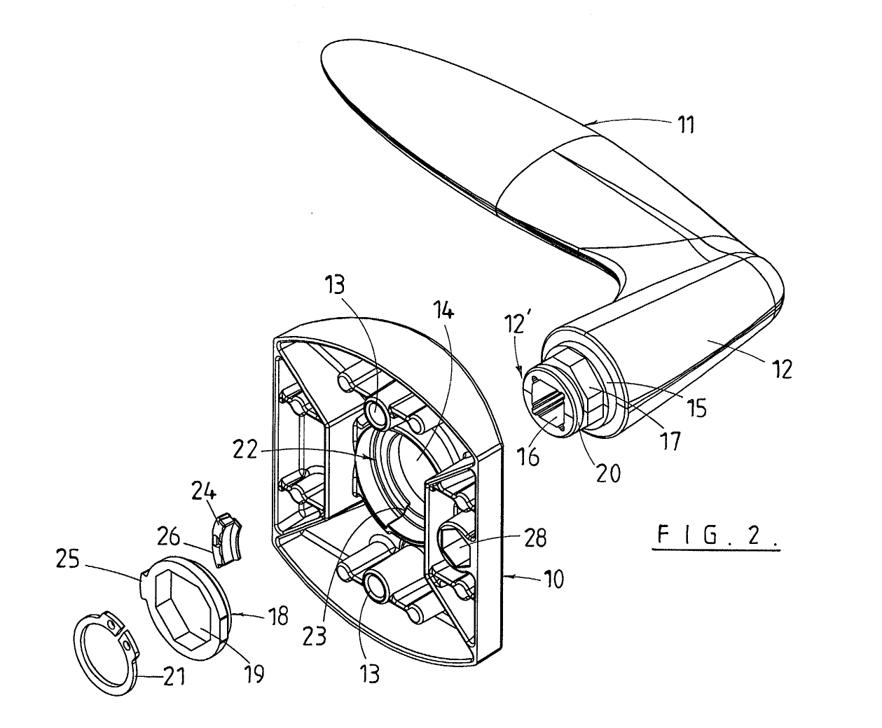

Referring now to FIG. 2, the escutcheon 10 has a circular opening 14 in which rotatably locates bearing surface 15 of the boss 12′ of the body 12. Extending axially within the body 12 and boss 12′ is an angular (generally square cross-sectional shaped) bore 16. It is into this bore 16 that the shaft S fits.

The boss 12′ includes outboard of the bearing portion 15 an angular portion 17 which is generally octagonal in shape. A retainer washer 18 has a correspondingly shaped angular (octagonal) opening 19. The retainer washer 18 can thus fit onto angular portion 17.

In accordance with conventional practice, a circlip 21 engages on the distal end 20 of the lever handle body 12 to retain the boss in rotating connection with the escutcheon 10.

In accordance with the present invention, a guide 22 is formed adjacent the surface which defines opening 14. Inward steps 23 defining the end of guide 22 form abutments the reason for which will hereinafter become apparent.

According to the present invention, a backstop member 24 is provided. This is generally of arcuate shape as can be seen in FIG. 2. The backstop 24 is slidingly engaged with guide 22 and thus can move along the guide 22 between the limits formed by abutments 23. This backstop 24 can thus be considered to form a “floating” backstop.

Extending from the inner (relative to the outer surface of the escutcheon 10) surface of backstop 24 is a projection 26. A projection 25 extends from the peripheral edge of retainer washer 18. The relative position of projections 25 and 26 is such that, as will hereinafter be described, projection 25 can come into contact with the end of the backstop 24 which is opposite to the end nearest or in contact with an abutment surface 23.

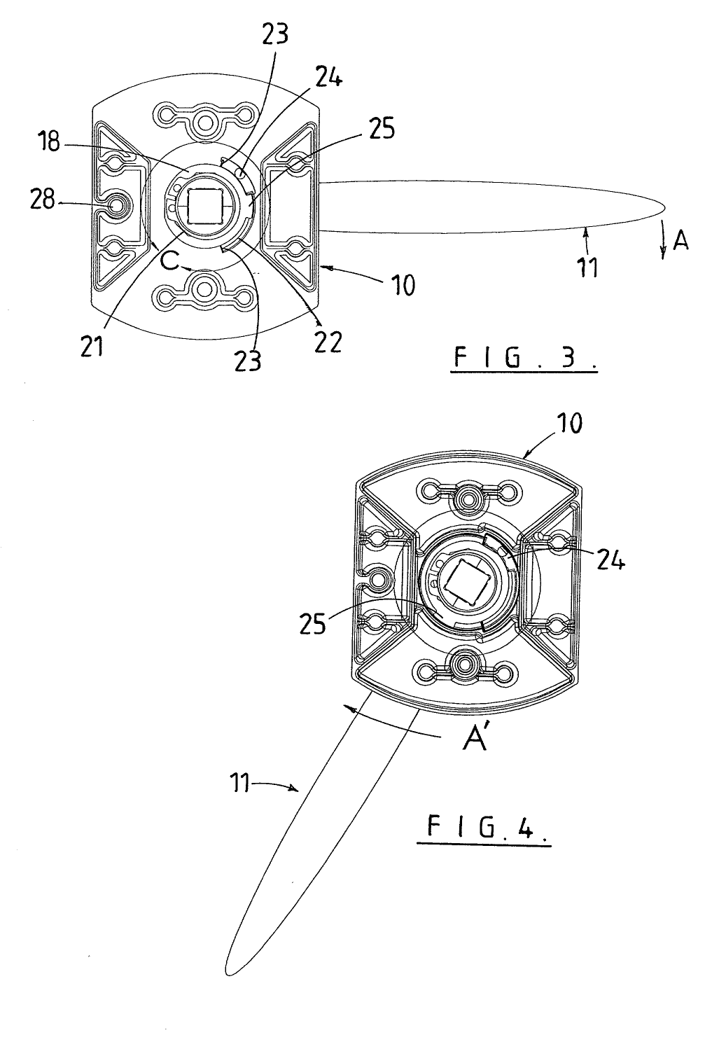

As can be seen in FIG. 3, the backstop 24 in the “rest” position of the lever handle is captive between the upper abutment surface 23 and an edge of abutment 25. The lever 11 can thus be moved in the direction of arrow A to rotate the shaft S engaged in bore 16 to thereby actuate the lock L. The extent of movement in direction A will, of course, be limited by the extent of movement of lock L to retract T. Thus, for example, lever 11 may move in the direction of arrow A by, say, up to 90°.

If the handing of the lever handle needs to be altered, it is a simple matter to release the escutcheon 10 from the door or at least release the shaft S from bore 16. Thus, generally, it will be necessary to remove one escutcheon 10 so that the shaft S can be released from the other escutcheon in a door set. Therefore, to change the handing of both lever handles only one needs to be actually demounted from the door.

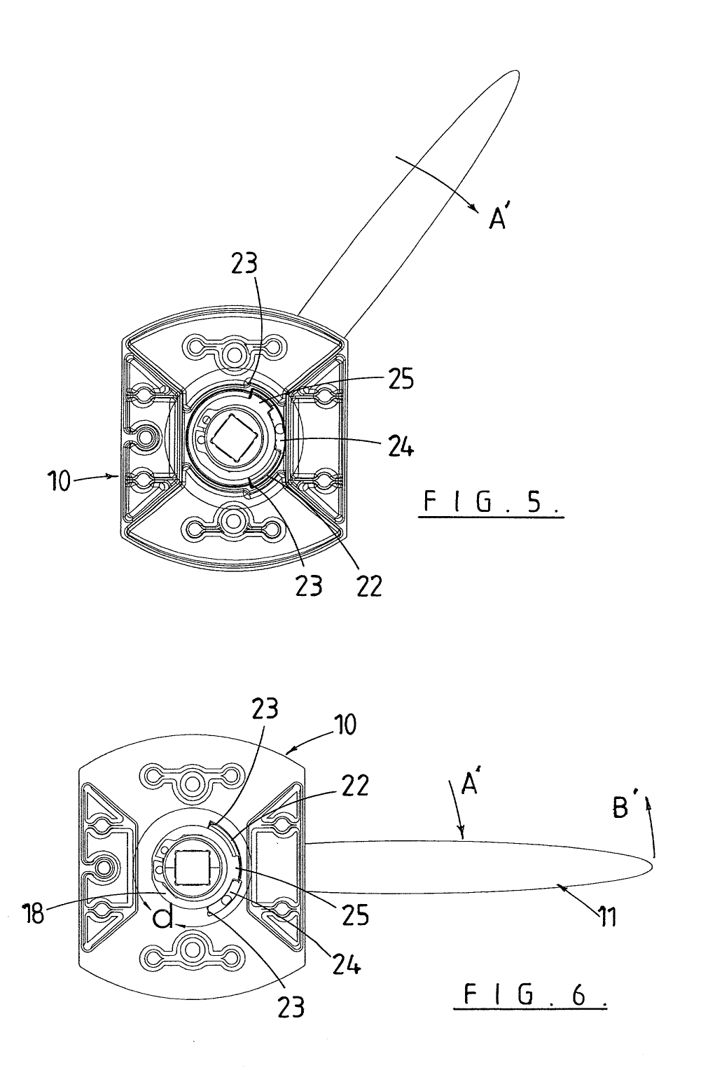

Once the extent of movement of lever 11 is not dictated by the extent of movement available by interengagement with lock L, the lever 11 can be moved as shown by arrow A′ in FIGS. 4, 5 and 6. As the handle moves back to the position shown in FIG. 3 (eg see FIG. 5), the other edge of projection 25 will come in contact with the end of backstop 24 adjacent or engaged with the upper abutment surface 23. Thus, when the lever 11 reaches the position shown in FIG. 6, the floating backstop 24 has been moved down into engagement with the lower abutment surface 23. In this position, operation of the lock would need to have the lever move in the direction of arrow B′. However, by rotating the entire lever handle assembly through 180° about the axis of body 12, the lever 11 will project on the other “hand”. Thus, the entire lever handle assembly can now be used on the opposite hand.

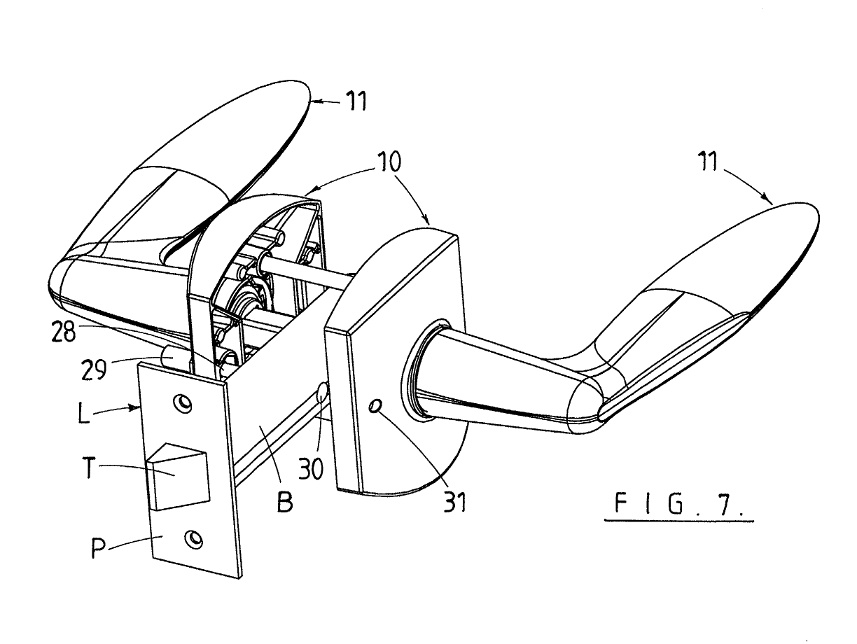

Locksets of this type can where privacy is required, eg bathrooms and toilets, include a privacy lock or button 29. This is mounted so that it can be pushed inwardly so that a part engages in an opening 30 in body B of the lock L so as to prevent the lock from operating. As shown in FIG. 7, a privacy lock override is provided whereby an opening 31 is formed in the escutcheon 10 to enable insertion of a wire into the latch mechanism to push the private button 29 from its engagement in the latch mechanism.

By being able to adjust the handing of the lever handle assembly as previously described, the privacy lock button will always be positioned in the correct location relative to the lever 11.

In a preferred form of the invention, an angular opening 28 is formed in the escutcheon 10. This enables an insert to be mounted for either the privacy button or the privacy override opening. Alternatively, a blanking insert could be located in opening 28 to blank off the opening in the event that a privacy lock mechanism is not required.

In another embodiment, the use of tooling inserts could be used during the manufacturing stage to result in the opening 28 not being formed in the escutcheon 10.

In accordance with the present invention, the floating backstop enables the handing of the lever handle assembly to be quickly and readily altered without any need of disassembly of the lever from the escutcheon. Therefore, when the handing of the lever handle assembly is determined (generally at the time of mounting the lever handle assemblies on a door) the lever 11 can be rotated to position the floating backstop in the correct position for the lever to be operable in a downward position and with the privacy lock mechanism located in the correct orientation relative to the latch mechanism L.

We claim:

1. A lever handle, including a lever rotatably mounted with an escutcheon, a stop element movably mounted within said escutcheon, a mover associated with said lever, and a limiter to limit movement of the stop element between limit positions.

2. The lever handle of claim 1 wherein the stop element is located for sliding movement along a guide in the escutcheon.

3. The lever handle of claim 2 wherein the guide is a curved path.

4. The lever handle of claim 3 wherein the guide is concentric with the axis of rotation of the lever.

5. The lever handle of claim 2 wherein the limiter is formed by abutments extending into the guide.

6. The lever handle of claim wherein the mover includes a projection that is engageable with a part of the stop element.

7. The lever handle of claim 1 wherein the mover is a handle retaining element engageable with the lever.

8. The lever handle of claim 7 wherein the handle retaining element includes a non-circular aperture adapted to receive a corresponding portion of the lever.

9. The lever handle of claim 7 wherein a clip means is provided to maintain the handle retaining element and lever in contact with the escutcheon.

10. The lever handle of claim 1 wherein the mover is contactable with either first or second surf aces of the stop element that in turn is contactable with the first or second surfaces of the limiter.

11. The lever handle according to claim 1 combined with a latch means, wherein movement of the lever retracts a tongue element of the latch means.

12. A method of configuring the handing of a lever handle as defined by claim 11 in a door structure wherein the escutcheon is disengaged from the latch means and the lever is rotated relative to the escutcheon to enable the lever handle to be installed with the latch means of the door in a substantially horizontal orientation and pointing to a hinged side of the door, wherein the stop means is located in contact between the moving means and the limit means and preventing upward movement of the lever.
